(19) United States
(12) Patent Application Publication
(10) Pub. No.: US 2012/0102184 A1
(43) Pub. Date: Apr. 26, 2012

(54) APPARATUS AND METHOD FOR ADAPTIVE STREAMING OF CONTENT WITH USER-INITIATED QUALITY ADJUSTMENTS

(75) Inventor: Brant L. Candelore, San Diego, CA (US)

(73) Assignee: SONY CORPORATION, Tokyo (JP)

(21) Appl. No.: 12/908,728

(22) Filed: Oct. 20, 2010

(51) Int. Cl. G06F 15/173; G06F 15/16

(52) U.S. Cl. 709/224; 709/231; 709/235

(57) ABSTRACT

According to one embodiment of the invention, a digital device comprises adaptive streaming logic to control a manual setting of play parameters that are used to adjust a display resolution of the incoming content and a data rate at which the streaming content is downloaded to the content interface unit. Hence, very low resolution content or greatly varying resolution which can be annoying to a viewer caused by excessive network congestion can be avoided or mitigated.

### FIELD

The invention is related to the field of content delivery. More specifically, certain embodiments of the invention are directed to adaptive streaming of content that allows a user to set parameters to override existing automated streaming controls or to adjust streaming on-the-fly when automated streaming controls are not available.

### BACKGROUND

Currently, television is widely used as a source of both information and entertainment. Televisions are adapted to receive programming content from selected cable and/or satellite providers which broadcast tens or even hundreds of channels of programming content. Also, televisions now are adapted for Internet connectivity to enable the television to receive and display content that is streamed from a number of Internet Protocol (IP) content providers and networked home servers.

Currently, bandwidth in the amount of two megabits per second (2 Mbps) is needed to provide a high definition 720p of Advanced Video Codec (AVC) content. Unfortunately, in the U.S., such bandwidth requirements are unavailable to half of the viewing audience. In order to reach the widest audience, some IP content providers such as YouTube® have encoded content to the lowest bit rate commonly supported by the viewing audience, somewhere in the range of 300-500 kilobits per second (Kbps). For example, one television broadcaster delivered live streams of Olympic coverage at a reduced bit rate (i.e. 650 Kbps) to capture a wider viewing audience.

Recently, a number of methods referred to as “adaptive streaming” have been developed to handle client with changing bandwidth connectivity. In adaptive streaming, a movie is encoded with different quality levels. The different movies can be broken up into segments or managed as contiguous content with similar entry points. In the discussion below, we discuss the method using segments. The encoding could be real-time on an “as needed per client” basis, but typically it is done ahead of time and the various encoded segments are stored pre-provisioned on a fulfillment server. For example, the lowest quality level could be 300 Kbps and the highest could be 3 Mbps. The duration of each segment is arbitrary such as between 3-10 seconds in duration. Hence, depending on network conditions, a client device can request content with the highest resolution if such content can be played without causing a stall.

For instance, when there is network congestion, the client requests lower resolution segments. As the congestion improves, higher resolution segments may be requested again. The content server over the Internet is essentially stateless, responding to requests for lower or higher resolutions segments from a myriad of clients. Therefore, adaptive streaming is good at keeping content streaming to the client with changes in resolution as needed.

However, conventional adaptive streaming algorithms can often be “fooled” because certain service providers have features that allow an initial higher bit rate to a client for quick downloads of small files. As a result, some content is streamed at this higher bit rate, with a later reduction in bit rate (referred to as “downres'd”) to accommodate the actual bit rate allowed for that customer. This can be annoying to a customer who may have watched a trailer, e.g. a free preview, believes that the viewing experience will be excellent, and now only to see the content resolution get downgraded. Hence, some customers might wish to prevent the streaming of and paying for very high resolution content since such content might inevitably get downres'd.

Also, since the Internet relies on a shared network, some customers may have neighbors who utilize a large percentage of the available bandwidth. Intermittent and sporadic loading of traffic will cause the resolution of adaptively streamed content to change continuously. This can be annoying to a customer as well. Likewise, there may be multiple members of a household using the home network, which can cause intermittent and sporadic loading of traffic on the home network. In the home, the final link to either the Internet or the home network may be a wireless connection such as wireless fidelity (WiFi), such as using IEEE 802.11a/b/g/n or another communication protocol which is susceptible to interference and can cause traffic problems.

In summary, conventional adaptive streaming with automated controls is static and fails to take into account user preferences. It is meant for ease of use without involving the customer in the details of format, resolution and bandwidth. For instance, the static streaming controls handles network congestion in a universal manner without accounting for situations where one type of user may want to maintain high definition (HD) picture quality despite stall conditions while another user may want reduced resolution up to a certain maximum if stalls can be prevented and the resolution can be kept more constant and less annoying.

Hence, there is a need for a system and method that supports adaptive streaming of content by allowing its users to set play (viewing and/or listening) parameters in response to a predetermined event (e.g., streaming application invocation, selection to begin receipt of streaming content, a user remote control key press while streaming, etc.).

### BRIEF DESCRIPTION OF THE DRAWINGS

The present invention is illustrated by way of example, and not by way of limitation, in the figures of the accompanying drawings and in which:

FIG. 1A is a first exemplary embodiment of a system implementing adaptive streaming logic within a digital device.

FIG. 1B is a second exemplary embodiment of a system implementing adaptive streaming logic within a digital device.

FIG. 1C is a second exemplary embodiment of a system implementing adaptive streaming logic within a digital device.

FIG. 2 is an exemplary embodiment of the digital device of FIG. 1B.

FIG. 3A is an exemplary embodiment of a user interface produced by the adaptive streaming logic of the digital device to perform initial adjustments of processing parameters for the playing of streaming content.

FIG. 3B is an exemplary embodiment of a user interface produced by the adaptive streaming logic of the digital device in response to signaling from a remote control in order to adjust processing parameters for playing streaming content.

FIG. 3C is an exemplary embodiment of a user interface produced by the adaptive streaming logic of the digital device in response to movement of a cursor over a display area that renders a control panel for adjusting processing parameters for playing streaming content.

FIG. 4 is a first exemplary embodiment of a flowchart highlighting the handling of the play of streaming data to combat excessive network congestion.

FIG. 5 is a second exemplary embodiment of a flowchart highlighting the handling of the playing of streaming data to combat excessive network congestion

### DETAILED DESCRIPTION

In the following description, for the purposes of explanation, numerous specific details are set forth in order to provide a thorough understanding of the present invention. The following description provides exemplary embodiments of the invention, and the accompanying drawings show these various exemplary embodiments for illustrative purposes. However, these examples should not be construed in a limiting sense as they are merely intended to provide exemplary embodiments of the invention rather than to provide an exhaustive list of all possible implementations. In other instances, well-known structures and devices are not shown in order to avoid obscuring the details of the invention.

In the following description, certain terminology is used to describe features of the invention. For instance, the term “digital device” may refer to electronic equipment that is adapted to render content received from one or more content providers or home network server. The “content” may include video, audio, images, or any combination thereof. Examples of “electronic equipment” may include, but are not limited or restricted to a television, a set-top box, a video game console, a personal digital assistant (PDA), a computer, a cellular telephone such as a smartphone, a portable or stationary music player, a personal video recorder (PVR), or the like. Also, examples of a “content provider” include, but are not limited or restricted to a terrestrial broadcaster, a cable or satellite television distribution system, or any company providing content for download over the Internet or other Internet Protocol (IP) based networks like an Internet Service Provider (ISP). Examples of home network servers are computers with the Windows® OS or network Personal Video Recorder (PVR) supporting Digital Network Living Alliance (DNLA) protocols. These protocols can allow a device, such as a television for example, to discover content located on a computer or network PVR in a home and initiate a stream of the content from the computer or PVR to that device over IP.

Herein, the terms “play” or “playing” generally represent the output of video and/or audio. Similarly, the term “playback”, in our description, is generally used to denote the retrieval of content from local storage followed by the rendering of perceivable content such as displaying content on screen or outputting audio content. This is to be differentiated from the playing of content from remote storage such as from Internet Service Providers (ISPs) or home network servers.

In certain situations, the terms “unit” and “logic” are representative of hardware, firmware and/or software configured to perform one or more functions. Examples of “hardware” include, but are not limited or restricted to an integrated circuit such as memory or a processor (e.g., a digital signal processor, microprocessor, application specific integrated circuit, a micro-controller, a type of programmable gate array, etc.). Of course, the hardware simply may be a collection of combinatorial logic.

An example of “software” includes code that may be executed such as an application, an applet, a subroutine, a series of instructions or information that can be transformed into instructions, or the like. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory, hard disk drive, etc.), a flash drive, a floppy diskette, an optical disc (e.g., compact disc or digital video disc “DVD”), magnetic tape, or the like.

I. Exemplary System/Device Architecture

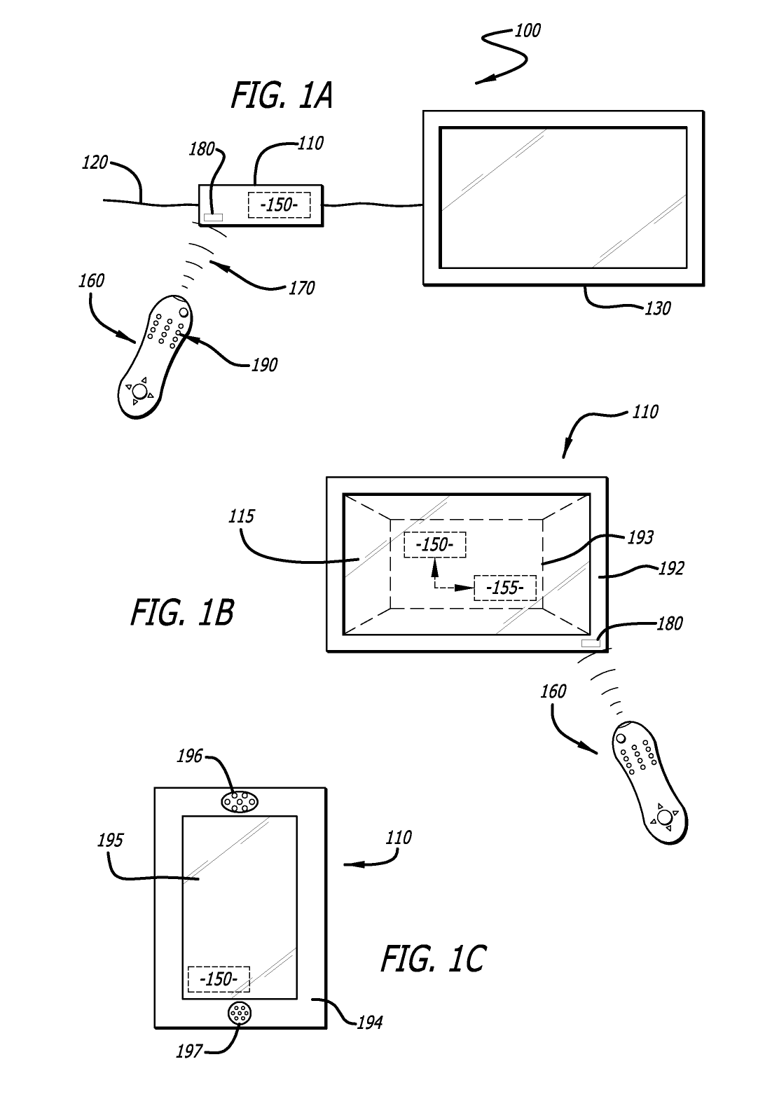

Referring to FIG. 1A, a first exemplary embodiment of a content delivery system 100 implementing adaptive streaming logic 150 within a targeted destination is shown. One purpose of content delivery system 100 is to deliver content from a content provider or home network server to a targeted destination. This targeted designation may include a digital device 110 (e.g., set-top box, PVR, etc.) that is in communication with one or more content providers or home network server over input link(s) 120 to receive the content such as streaming content.

“Streaming content” is content that is normally processed for immediate rendering. Such processing may involve temporary buffering of the content to allow for network congestion and also for content decoding processing by the digital device. Depending on the copy protection rules applied to the content, the content may also be recorded. The playback of this recorded content may be controlled by usage rules.

According to this embodiment of the invention, digital device 110 is further coupled to a second digital device, such as a television 130 for example, that is adapted to display the content. The link between the two devices 110 and 130 may be High-bandwidth Digital Multimedia Interface (HDMI), baseband video and audio, RF channel 3/4 or the like. According to this embodiment of the invention, digital device 110 includes adaptive streaming logic 150 that is designed to dynamically adjust play parameters based on user preferences and network conditions. Such adjustments generally constitute (i) a manual override that alters existing automatic streaming controls that handle stalls and other play problems caused by excessive network congestion, or (ii) a user “on-the-fly” mechanism that can adjust play parameters based on user-initiated commands where no streaming controls are present.

In the case of a user “on-the-fly” mechanism, the user can manually increase or decrease the requested resolution as described previously regarding adaptive streaming. The user can respond to content rendered on a display screen and to content stalls, namely where the image on screen either freezes or goes black, by judging whether the resolution should be increased or decreased.

For the first exemplary adjustment scheme, as an example, adaptive streaming logic 150 is designed to increase and/or decrease resolution and data rates for playing the streaming content according to predefined ranges established by the user. Adaptive streaming logic 150 may be adapted to monitor networking activity and respond accordingly in an automatic fashion. Such monitoring may be accomplished by analyzing the capacity of data buffers within digital device 110 in which data is retrieved for output (play), data throughput via an input port that is receiving streaming content, or the like.

Being a wireless controller that is remotely located from digital device 110, a remote 160 may be used to set or control the operations of adaptive streaming logic 150. Of course, other interfaces such as a keypad, keyboard or the like may be used in lieu of remote 160. Herein, as shown, remote 160 is adapted to communicate commands through a communication link 170 established between remote 160 and digital device 110. These commands, in the form of light pulses for example, are subsequently detected by a LED detector 180 located on digital device 110 and translated into signaling recognized by adaptive streaming logic 150 or other circuitry within digital device 110. Alternatively, link 170 may be radio-frequency (RF) signaling or wireless signaling of other bandwidths where detector 180 constitutes an RF detector.

As shown, a particular command from remote 160 may be produced by depressing one or more buttons 190 accessible on an outer top surface of remote 160. Buttons 190 may include a power button, a MENU button, a key of a keypad designating numerals and/or characters, one of the multidirectional arrows that provide scrolling as needed, a dedicated streaming control button, or the like. Alternatively, the particular command may be signaling the orientation of remote control 160 with respect to detector 180, namely data that can be used to display a cursor and its computed location.

Referring now to FIG. 1B, a second exemplary embodiment of content delivery system 100 implementing adaptive streaming logic 150 within digital device 110 is shown. Herein, digital device 110 is a device with a display screen 115, namely a flat paneled television. Detector 180 is implemented within a casing 192 of digital device 110.

According to one embodiment of the invention, detector 180 detects signals from remote 160 and transfers those signals (e.g. commands) to a processor 155 located on a back cabinet 193 of television 110. Processor 155 receives the commands and, in collective operation with adaptive streaming logic 150, displays a user interface for adjusting parameters that are used to control playing of the streaming content by digital device 110. The user interface may include a window that lists the values of the play parameters and/or one or more adjustable images (e.g., bar graph, scale, etc.) that allow for adjustment the play parameters as described below.

After the play parameters are adjusted by the user, digital device 110 now retrieves blocks of streaming content from content providers or home network server that are in compliance to these play parameters. For instance, where the resolution is decreased from high-definition (HD) to standard (STD) definition, television 110 retrieves STD content from a content provider or home network server in lieu of HD content. This involves simply fetching different formatted and downres'd segments from the same content provider or home network server.

Of course, as an alternative embodiment, it is contemplated that detector 180 may direct such signaling to circuitry other than processor 155 or to adaptive streaming logic 150 directly. Thereafter, adaptive streaming logic 150, perhaps with assistance of the other circuitry, controls the playing of the streaming content.

Referring to FIG. 1C, a third exemplary embodiment of a system implementing adaptive streaming logic 150 within digital device 110 is shown. Herein, digital device 110 is portable with an integrated display. One example of portable digital device 110 is a cellular telephone, net computer, wireless tablet, or the like.

For this embodiment of the invention, digital device 110 includes a casing 194, a user interface 195 (e.g. a touch screen as shown, a keypad if a separate display is provided, etc.), a speaker 196 and a microphone 197. Herein, adaptive streaming logic 150 may be hardware, firmware and/or software such as a downloadable application that is executed by a processor implemented within casing 194 of digital device 110. For that embodiment of the invention, adaptive streaming logic 150 either can be (i) prestored within local memory of digital device 110 at manufacturer, (ii) stored prior to distribution to the user, or (iii) downloaded into local memory by the user initiating communications with a remote source such as an application server. These communications may be over a private or public network to an application server hosted by the cellular telephone service provider, a manufacturer or distributor of digital device 110, or an independent third party.

According to one embodiment of the invention, upon being implemented within digital device 110, adaptive streaming logic 150 operates in response to one or more user-initiated events. For instance, adaptive streaming logic 150 may display an icon that, when selected on touch screen 195, allows the user to alter certain parameters that control streaming content. Alternatively, in lieu of a separate icon, the adaptive streaming controls may be incorporated into the General Settings application that is user accessible. Yet another alternative embodiment is where adaptive streaming logic 150 renders a selectable image in the foreground or background that, when selected on touch screen 195, allows the user to alter one or more of the play parameters.

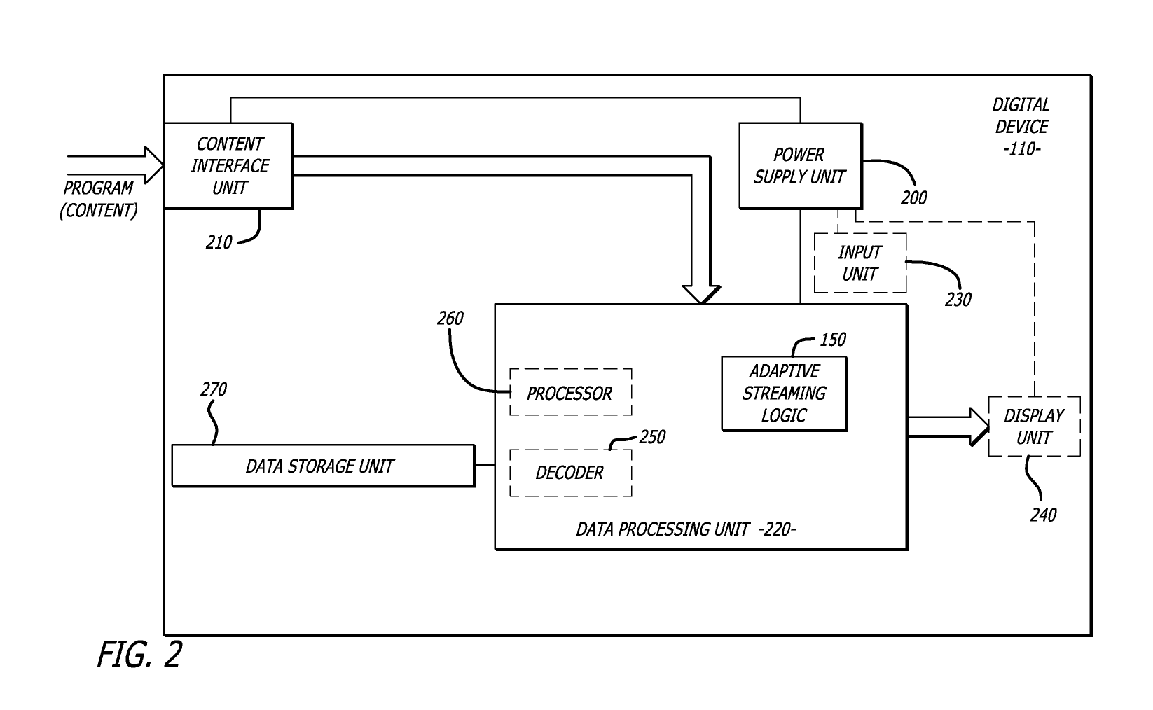

Referring now to FIG. 2, an exemplary diagram of an embodiment of digital device 110 of FIG. 1B is shown. According to this embodiment of the invention, digital device 110 comprises a power supply unit 200, a content interface unit 210 and data processing unit 220. As optional features represented by dashed lines, digital device 110 may include an input unit 230, a display unit 240 and a speaker 245. In particular, input unit 230 may be implemented as an integral part of digital device 110 or may be separate and remotely located from digital device 110 (not shown). Similarly, display unit 240 may be implemented as an integral part of digital device 110 or may be separate and remotely located (not shown).

According to this embodiment of the invention, power supply unit 200 is adapted to provide power to a content interface unit 210 and data processing unit 220 as well as input unit 230 or display unit 240 where appropriate. Power supply unit 200 may provide regulated power based on input power received from a wall socket (e.g., 110 volts alternating current “VAC”, 220 VAC, etc.) or may include a rechargeable or non-rechargeable battery implemented within digital device 110.

Content interface unit 210 is adapted to receive streaming content and perhaps alter the content to recover an audiovisual program. The altering may involve decoding, demodulating or descrambling the incoming streaming content. The audiovisual program is routed as one or more digital bit streams to data processing unit 220. Examples of content interface unit 210 may include, but are not limited or restricted to one or more of the following: an Ethernet connector, a wireless receiver such as WiFi using IEEE 802.11a/b/g/n, a Data Over Cable Service Interface Specification (DOCSIS) receiver, Multimedia Over Coax Alliance (MoCA) receiver, a tuner/demodulator that tunes to one or more RF communication channels, or the like.

According to one embodiment of the invention, data processing unit 220 comprises adaptive streaming logic 150 as well as a decoder 250 and/or processor 260. These components may be implemented as separate integrated circuits or as a single integrated circuit. As described herein, decoder 250 is implemented to decode the streamed audiovisual program, where the program is encoded (e.g., obfuscated in a selected manner such as scrambled, encrypted, or the like). After such decoding, certain data within the audiovisual program may be processed by processor 260 and output to display unit 240 and/or speaker 245.

According to one embodiment of the invention, adaptive streaming logic 150 is separate from processor 260 and adapted to, in response to one or more user-initiated events, generate interfaces for setting user preferences for playing streaming content based on different levels of network congestion as well as for controlling such play in accordance with these preferences.

According to another embodiment of the invention, adaptive streaming logic 150 is stored within a data storage unit 270. Data storage unit 270 operates as local memory for digital device 110 and stores adaptive streaming logic 150 therein. Processor 260 executes adaptive streaming logic 150 in order to enable a user to set play parameters for streaming content based on different levels of network congestion and to control such playing in accordance with these preferences.

II. Exemplary Streaming Content Parameter Settings

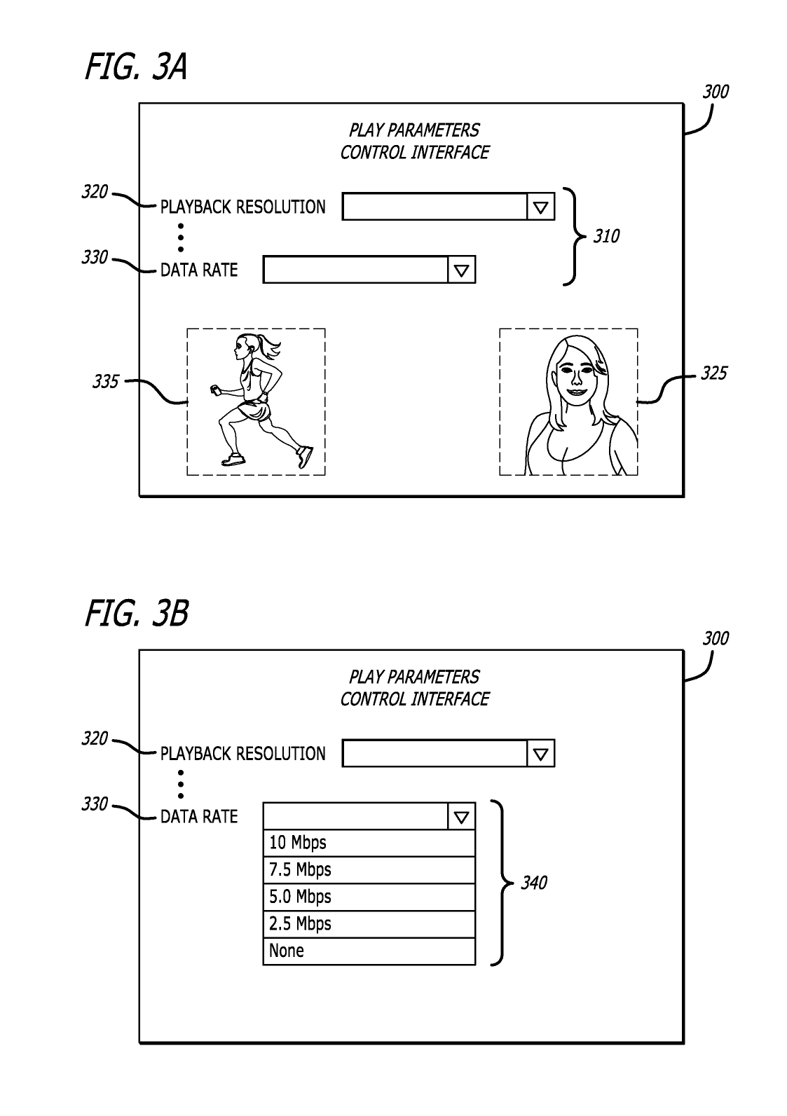

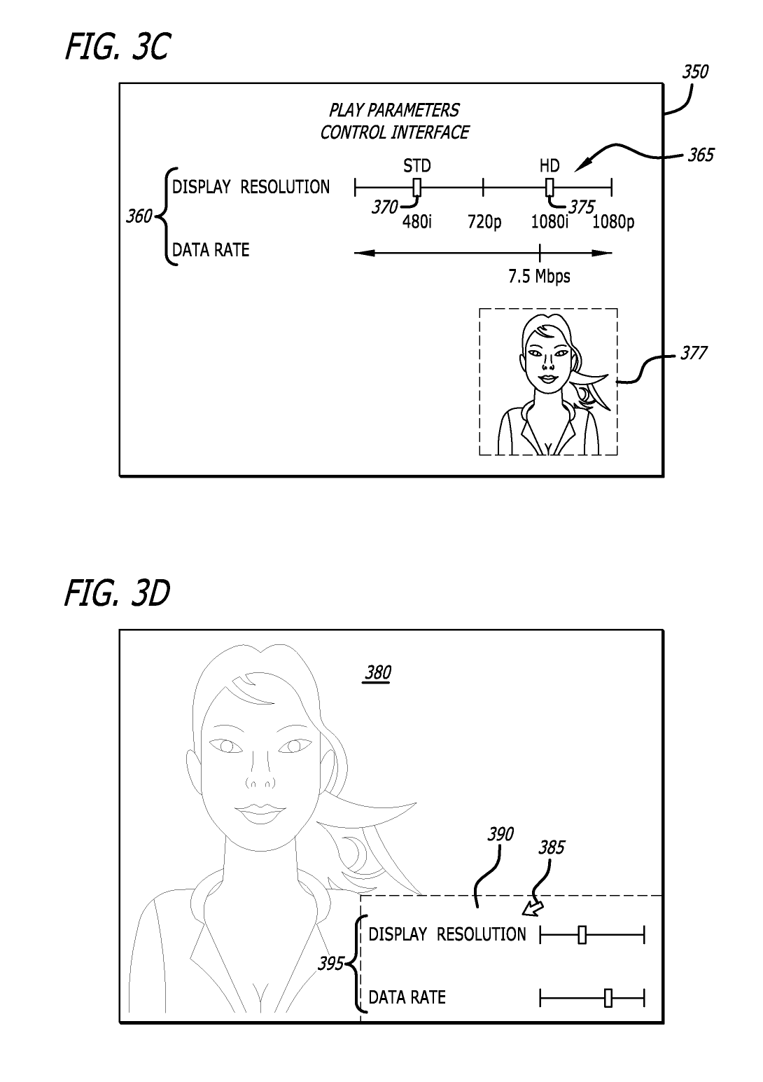

Referring to FIG. 3A, a first exemplary embodiment of a user interface 300 produced by adaptive streaming logic 150 of digital device 110 of FIG. 2 is shown. Herein, user interface 300 is adapted for setting parameters to control the streaming of content. More specifically, user interface 300 is displayed on a display screen controlled by digital device 110 in order to allow the user or group of users to set play parameters 310 to customize and adjust the streaming of content if certain conditions are experienced (e.g., a stall is detected, a certain amount of data is not buffered so that an upcoming stall is likely, etc.).

For instance, one of play parameters 310 may include a resolution parameter 320 that is used to adjust the display resolution of incoming video if certain adverse play conditions are detected. These play conditions may include an amount of buffered content rising above or falling below a particular level, a throughput rate rising above or falling below a particular level, or the like. As an optional feature, during adjustment of the display resolution, an image 325 at that resolution may be displayed to provide the user with a visual perspective for determining what resolution is or would be acceptable to the user. Resolution parameter 320 may be represented by a single value (e.g., minimum resolution) or a range of values.

Similarly, play parameter 310 may include a minimum and/or maximum data rate parameter 330 that is used to adjust the rate of transmission of the streaming content from a content provider or home network server if certain play conditions occur as described above. The parameters act as an override on the automatic adaptive streaming logic 150. As an optional feature, exemplary streaming content 335 displayed at the proposed reduced or increased data rate may provide the user with a visual perspective as to what minimal or maximum data throughout is or would be acceptable. This displayed content may be the same as image 325 (illustrating resolution and data rate together) or separate images. Data rate parameter 330 may include a single value (e.g., minimum data rate) or a range of values.

As a result, such parameters allow a user to set a minimum bit rate if she is willing to suffer through stalls in order to display higher resolution content. Likewise, a user setting a maximum bit rate is attempting to keep the displayed resolution more constant in order to avoid noticeable changes in the rendered content. Of course, it is contemplated that both a minimum parameter and a maximum parameter may be set at the same time in order to provide content rendering at an acceptable level for this particular user.

For some or all of play parameters 300, as shown in FIG. 3B, pull-down menus 340 may be provided to allow the viewer to select the appropriate entry. For instance, as shown, a pull-down menu may be provided for data rate parameter 330 and allow for the selection of five (5) maximum entry selections: 10 megabits per second (Mbps); 7.5 Mbps; 5.0 Mbps; 2.5 Mbps and None. Likewise, there can be a minimum entry selection: 10 megabits per second (Mbps); 7.5 Mbps; 5.0 Mbps; 2.5 Mbps and None. The selection “None” means there is either no minimum or maximum. If a user picks the same value, e.g. 5 Mbps, then the content is streamed at essentially the same rate of 5 Mbps. In the case that there is no adaptive streaming client on the device, the user is able to adjust (i.e. “bump”) the bit rate or resolution up or down based on the quality of video rendered on screen and any perceived stalls.

Referring to both FIGS. 3A and 3B, after selecting a particular entry, once the digital device is unable to support the current date rate, it reduces the data rate to the value set forth in minimum data rate parameter 330, if a minimum was set, or an intermediary value where the preset data rate is merely utilized as a minimum in a controlled reduction. For instance, when operating at 10 Mbps and data rate parameter 330 being set at 5 Mbps, upon experiencing unacceptable network congestion effecting the operation of digital device 110, adaptive stream logic may set the data rate to be 5 Mbps, or the data rate may be initially to an intermediary value (e.g. 7.5 Mbps) before reverting to 5 Mbps if needed. Likewise, if the maximum parameter 330 was set to 7.5 Mbps, if network congestion is ameliorated, a bit rate of 5 Mbps would increase to 7.5 Mbps but not 10 Mbps even if the network could sustain it for a period of time.

Referring to FIG. 3C, a second exemplary embodiment of a user interface 350 produced by adaptive streaming logic 150 of digital device 110 of FIG. 2 for setting parameters to control the streaming of content is shown. Herein, user interface 350 is displayed by digital device 110 in order to allow the user or group of users to set parameters 360 to customize adjustment in the streaming content, e.g. minimum and maximum resolution and bit rate, if certain play conditions are experienced such as a stall, low buffer usage so that an upcoming stall is likely, or the like, or that the opposite is happening, e.g. the network congestion is clearing up and a higher bit rate would be possible at that moment.

For instance, one of play parameters 360 may be adjusted by modifying an image 365, such as a scale as shown, to set an acceptable minimum or a selected range of values for that play parameter 360. Where play parameter 360 is associated with display resolution, the adjustment of one or more boundary elements 370 and/or 375 defines the threshold or boundaries as to how much display resolution can be reduced or increased based on network congestion. For instance, the minimum threshold has been set to 480i (National Television System Committee “NTSC”-generally 720×480 split into two interlaced fields of 243 lines) while, if a range is considered, the maximum resolution is 1080i (HD—generally 1920×1080 split into two interlaced fields of 540 lines). As an optional feature, during adjustment of the display resolution, an image 377 at that resolution may be displayed to provide the user with a visual perspective as to what resolutions are and are not acceptable to the user.

Referring now to FIG. 3D, a third exemplary embodiment of a user interface 380 produced by adaptive streaming logic 150 of digital device 110 of FIG. 2 for setting parameters to control play of streaming content is shown. Herein, user interface 380 is displayed by digital device 110 in order to allow the user or group of users to set play parameters to customize adjustment in the play of streaming content if certain conditions are experienced such as a stall, a buffer with minimal data rate so that an upcoming stall is likely, or the like in the case of setting a maximum bit rate, or a minimum bit rate in case of maintaining a particular resolution of the content.

For instance, one or more of the play parameters may be adjusted through remote control 160 that, based on its orientation, causes a cursor 385 to be displayed. In particular, movement of cursor 385 over a particular display area 390 causes play parameter controls 395, normally overlaid by the displayed picture, to be placed in the foreground. Thereafter, play parameter controls 395 may be adjusted as described in FIGS. 3A and 3C.

III. Exemplary Play Parameter Adjustment Scheme

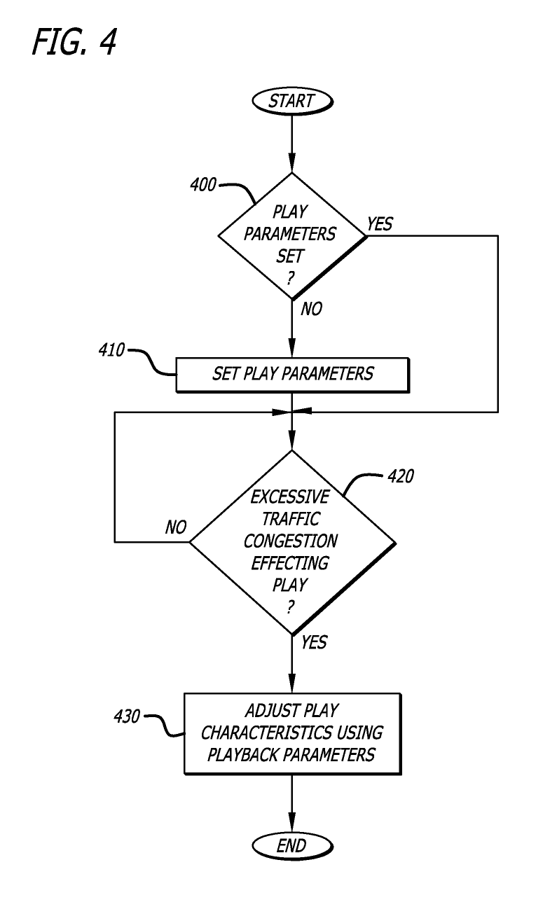

Referring now to FIG. 4, a first exemplary embodiment of a flowchart highlighting the handling of the play of streaming data to combat excessive network congestion is shown. First, a determination is made whether the play parameters that control resolution and data rate transmission schemes for incoming streaming content are set (block 400). For most adaptive streaming scenarios, the user need not change the parameters. But a viewer may wish to optimize the streaming based on the consumer's particular network conditions or content preferences, e.g. always wanting a minimum higher quality content. If not, in response to an event such as registration or power-up, the digital device generates an interface to encourage the user to set her play preferences for incoming content, notably resolution and data rate (block 410).

However, if the play parameters have been set, a determination is made whether there is excessive traffic congestion affecting play (block 420). This may be performed by logic within the digital device that analyzes usage of internal storage, data propagation through a data port of the digital device, or the like. Thereafter, the play characteristics are adjusted by modifying the play parameters (block 430). The adjustment may be controlled entirely by the user herself or may be guided by logic within the digital device that notifies when the setting is such that the detected play condition(s) is(are) corrected.

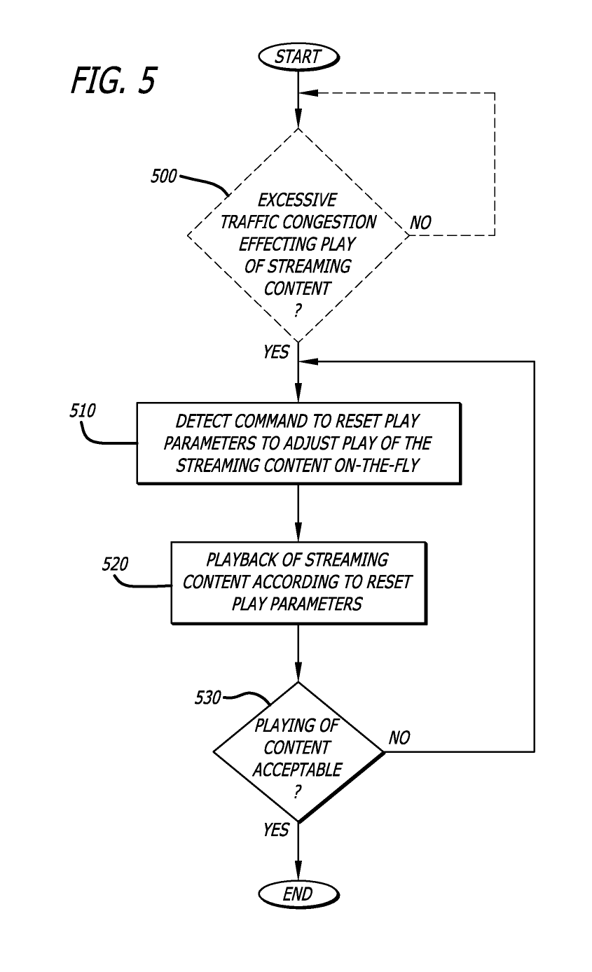

Referring to FIG. 5, a second exemplary embodiment of a flowchart highlighting the handling of the play of streaming data to combat excessive network congestion is shown. As an optional feature, a determination is made whether there is excessive traffic congestion affecting play of streaming content (block 500). This may be performed by logic within the digital device that analyzes display or sound buffer usage, data propagation through a data port of the digital device, or the like.

Regardless, the digital device monitors and may detect commands from a remote source to set the play parameters for adjusting play of the streaming content on-the-fly (block 510). In response to such commands, logic within the digital device await signaling associated with the user's modifications of play parameters identified in a displayed user interface and alters the play characteristics of the digital device. Such alternations are designed to address undesirable play conditions caused by network conditions.

Thereafter, the streaming content is played back according to the reset values of these play parameters (block 520). Additional analysis may be conducted to determine whether any additional adjustment of the play parameter is necessary (block 530).

Having disclosed exemplary embodiments and the best mode, modifications and variations may be made to the disclosed embodiments while remaining within the spirit of the invention as defined by the following claims.

What is claimed is:

1. A digital device comprising:
a content interface unit; and
a data processing unit adapted to receive incoming content from the content interface unit, the data processing unit comprises adaptive streaming logic to control a manual setting of play parameters and using values selected for the play parameters to adjust a display resolution of the incoming content and a data rate at which the incoming content is streamed to the content interface unit upon detection of a play condition.

2. The digital device of claim 1 further comprising:
a display unit coupled to the data processing unit;
a speaker coupled to the data processing unit; and
an input unit in communication with the data processing unit.

3. The digital device of claim 2, wherein, in response to a user-initiated event, the adaptive streaming logic of the data processing unit generates a user interface for display on the display unit, the user interface enables manual setting of values for the play parameters based on different levels of network congestion where one of the levels of network congestion constitute the play condition.

4. The digital device of claim 3, wherein the adaptive streaming logic of the data processing unit determines a level of network congestion by monitoring an amount of buffered content stored within an internal memory unit of the digital device.

5. The digital device of claim 2, wherein, in response to a user-initiated event, the adaptive streaming logic of the data processing unit generates a user interface for display on the display unit, the user interface includes a resolution parameter to adjust a display resolution if the play condition is detected.

6. The digital device of claim 5, wherein the play condition is a stall condition.

7. The digital device of claim 5, wherein the adaptive streaming logic of the data processing unit generates an image having a resolution according to the resolution parameter to provide a visual perspective whether the resolution of the image is acceptable.

8. The digital device of claim 2, wherein, in response to a user-initiated event, the adaptive streaming logic of the data processing unit generates a user interface for display on the display unit, the user interface includes a data rate parameter to manually adjust a data throughput threshold so that a data rate of the incoming content fetched by the adaptive streaming logic does not exceed or does not go below a certain data throughput threshold.

9. The digital device of claim 8, wherein the adaptive streaming logic of the data processing unit displays a portion of the incoming content at the data rate set by the data rate parameter to provide a visual perspective whether the resolution of the portion of the incoming content is acceptable.

10. A method comprising
generating a user interface by a digital device for setting at least one parameter of a plurality of parameters in order to adjust a rendering of segments of incoming content received by the digital device, the plurality of parameters include (i) a first parameter that sets a threshold for perceived resolution during rendering of incoming content and (ii) a second parameter that sets a threshold for a transmission rate of the incoming content supported by the digital device;
in response to detection of an adverse play condition experienced by the digital device, adjusting retrieval of the segments of the incoming content at reduced clarity as limited by the first parameter or at a reduced transmission rate as limited by the second parameter.

11. The method of claim 10, wherein the first parameter sets a minimum display resolution for the segments of the incoming content upon detection of the adverse play condition by the digital device.

12. The method of claim 11, wherein the adverse play condition is a stall condition experienced by the digital device.

13. The method of claim 10, wherein the first parameter sets a minimum audio play resolution for the segments of the incoming content upon detection of the adverse play condition by the digital device.

14. The method of claim 11, wherein the second parameter sets a minimum data throughput threshold so that a data rate of the segments of the incoming content fetched by the digital device do not fall below the minimum data throughput threshold.

15. Software stored in a tangible machine readable medium within a digital device being part of a network and executed by a processor to perform operations of:
generating a user interface to set play parameters being characteristics that effect a quality level for content output by the digital device;
determining if excessive network congestion exists where the digital device will experience problems in rendering incoming content; and
retrieving successive segments of incoming content in accordance with the play parameters upon determining that excessive network congestion exists.

16. The software of claim 15 being executed to retrieve the successive segments of incoming content having a lesser resolution than segments of the incoming content prior to determining that excessive network congestion exists.

17. The software of claim 15 being executed to retrieve the successive segments of incoming content at a lesser data rate than segments of the incoming content transmitted prior to determining that excessive network congestion exists.
